(19) United States
(12) Patent Application Publication
(10) Pub. No.: US 2015/0253257 A1
(43) Pub. Date: Sep. 10, 2015

(54) METHOD FOR AUTOMATIC INSPECT OF CONTACT LENSES

(71) Applicant: Novartis AG, Basel (CH)

(72) Inventor: Lance Kyle Lipscomb, Cumming, GA (US)

(21) Appl. No.: 14/636,404

(22) Filed: Mar. 3, 2015

Related U.S. Application Data
(60) Provisional application No. 61/948,255, filed on Mar. 5, 2014.

(51) Int. Cl. G01N 21/88; G02C 7/02; G01N 21/958; G02C 7/04

(52) U.S. Cl. CPC G01N 21/8806; G02C 7/049; G02C 7/021; G01N 21/958; G01N 2021/9583; G01N 2201/061

(57) ABSTRACT

Described herein is a method for automatically inspecting contact lenses having printed markings thereon for cosmetic defects. The method involves use of a colored optical filter to effectively eliminate the printed markings from the image being presented to the automated inspection system, thus preventing false rejects, while at the same time preventing the masking of actual defects.

This application claims the benefit under 35 U.S.C. §119 (e) of U.S. provisional application Ser. No. 61/948,255 filed on Mar. 5, 2014, herein incorporated by reference in its entirety.

This invention is related to a method for automatically inspecting contact lenses having printed markings thereon for cosmetic defects.

### BACKGROUND

Contact lenses have historically been engraved with various letters, numbers and symbols to indicate such things as company of manufacture, power, lens type, prism base, axis orientation, inversion etc. In most cases these marks have been engraved on the actual lens, or embossed into the lens as part of a molding/casting operation. While these markings have been effective for their purposes, there have been issues with comfort, awareness etc. As a result of this, there has been a movement to move away from engraving and embossing to the printing of markings onto contact lenses.

In order to assure constant quality of the contact lenses produced in a mass-production process, the lenses are inspected for cosmetic defects (e.g., tears, nicks, cuts, holes, folds chops, foreign bodies, bubbles, etc.) through the use of automated inspections systems. In the process of automatically inspecting the contact lens for cosmetic defects, the printed markings on the lenses may pose a problem for the inspection system as they may be falsely categorized as defects.

Various methods have been used to avoid rejecting good lenses due to the markings; these would include character recognition as well as masking the area of the lens containing the markings. These methods add cost and complexity to the inspection system, as well as risking that a defect under the masked portion of the lens would not be detected, thus compromising the effectiveness of the inspection process.

Therefore, there is still a need for a method for automatically inspecting contact lenses having printed markings thereon for cosmetic defects.

### SUMMARY

In one aspect, the invention provides a method for automatically inspecting contact lenses having printed markings thereon for cosmetic defects, the method comprising the steps of: (1) illuminating, with a white light, a contact lens having printed marks thereon with a white light, wherein the printed marks are composed of a colorant that transmits only a first light of wavelengths to impart a desired color; (2) taking an image of the contact lens from a second light that is transmitted through the contact lens and a color filter, wherein the color filter is capable of transmitting only the first light; (3) analyzing the image for detecting defects in the contact lenses.

These and other aspects, features and advantages of the invention will be understood with reference to the figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### DETAILED DESCRIPTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art. Also, as used in the specification including the appended claims, reference to singular forms such as “a,” “an,” and “the” include the plural, and reference to a particular numerical value includes at least that particular value, unless the context clearly dictates otherwise. “About” as used herein means that a number referred to as “about” comprises the recited number plus or minus 1-10% of that recited number.

“Optional” or “optionally” means that the subsequently described event or circumstance can or cannot occur, and that the description includes instances where the event or circumstance occurs and instances where it does not.

The present invention is generally directed to a method for automatically inspecting contact lenses having printed markings thereon for cosmetic defects. It is discovered that a colored optical filter can be used to effectively eliminate the printed markings from the image being presented to the automated inspection system, thus preventing false rejects, while at the same time preventing the masking of actual defects. One advantage of using this lens inspection method is that the automated inspection of contact lenses having printed marks thereon for cosmetic defects can be simplified without the need to develop sophisticated character recognition algorithms or masking algorithms which impact the effectiveness of the inspection process.

A “contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. Soft contact lenses are hydrogel contact lens or silicone hydrogel contact lenses. A “hydrogel contact lens” refers to a contact lens comprising a hydrogel material. A “silicone hydrogel contact lens” refers to a contact lens comprising a silicone hydrogel material.

Typically, a contact lens has an anterior surface and an opposite posterior surface and a circumferential edge where the anterior and posterior surfaces are tapered off.

The “front or anterior surface” of a contact lens, as used herein, refers to the surface of the lens that faces away from the eye during wear. The anterior surface, which is typically substantially convex, may also be referred to as the front curve of the lens.

The “rear or posterior surface” of a contact lens, as used herein, refers to the surface of the lens that faces towards the eye during wear. The rear surface, which is typically substantially concave, may also be referred to as the base curve of the lens.

“Cosmetic defects” refers to tears, nicks, cuts, holes, folds chops, foreign bodies, bubbles, or combinations thereof existed in a contact lens.

“Printed marks” refers to various letters, numbers, lines, symbols, or combinations thereon which indicate such things as company of manufacture, power, lens type, prism base, axis orientation, inversion, or combinations thereof and which are printed on a contact lens.

As used in this application, the term “hydrogel” or “hydrogel material” refers to a crosslinked polymeric material which is not water-soluble and can contains at least 10% by weight of water within its polymer matrix when fully hydrated. A “silicone hydrogel” refers to a hydrogel containing silicone, as known to a person skilled in the art.

In one aspect, the invention provides a method for automatically inspecting contact lenses having printed markings thereon for cosmetic defects, the method comprising the steps of: (1) illuminating, with a white light, a contact lens having printed marks thereon with a white light, wherein the printed marks are composed of a colorant that transmits only a first light of wavelengths to impart a desired color; (2) taking an image of the contact lens from a second light that is transmitted through the contact lens and a color filter, wherein the color filter is capable of transmitting only the first light; (3) analyzing the image for detecting defects in the contact lenses.

Contact lenses can be manufactured economically in a mass production manner by a conventional cast-molding process involving disposable molds (e.g., PCT published patent application No. WO/87/04390, EP-A 0 367 513, U.S. Pat. No. 5,894,002) or by the so-called Lightstream Technology™ (Alcon) which involving reusable molds and curing a lens-forming composition under a spatial limitation of actinic radiation (U.S. Pat. Nos. 5,508,317, 5,583,163, 5,789,464, 5,849,810, and 8,163,206).

Contact lenses can be made according to any methods well known to a person skilled in the art. For example, contact lenses can be produced in a conventional “spin-casting mold,” as described for example in U.S. Pat. No. 3,408,429, or by a conventional cast-molding process involving disposable molds (e.g., U.S. Pat. No. 4,347,198, U.S. Pat. No. 5,894,002, WO8704390, EP0367513) or by the so-called Lightstream Technology™ (Alcon) which involving reusable molds and curing a lens-forming composition under a spatial limitation of actinic radiation (U.S. Pat. Nos. 5,508,317, 5,583,163, 5,789,464, 5,849,810, and 8,163,206), or by lathe cutting of buttons as used in making customized contact lenses.

For production of contact lenses, a lens formulation for cast-molding or spin-cast molding or for making rods used in lathe-cutting of contact lenses generally comprises at least one components selected from the group consisting of a silicone-containing vinylic monomer, a silicone-containing vinylic macromer, a silicone-containing prepolymer, a hydrophilic vinylic monomer, a hydrophobic vinylic monomer, a crosslinking agent, a free-radical initiator (photoinitiator or thermal initiator), a hydrophilic vinylic macromer/prepolymer, and combination thereof, as well known to a person skilled in the art. A contact lens formulation can also comprise other necessary components known to a person skilled in the art, such as, for example, a UV-absorbing agent, a visibility tinting agent (e.g., dyes, pigments, or mixtures thereof), antimicrobial agents (e.g., preferably silver nanoparticles), a bioactive agent, leachable lubricants, leachable tear-stabilizing agents, and mixtures thereof, as known to a person skilled in the art. Resultant contact lenses then can be subjected to extraction with an extraction solvent to remove unpolymerized components from the resultant lenses and to hydration process, as known by a person skilled in the art.

Lens molds for making contact lenses are well known to a person skilled in the art and, for example, are employed in cast molding or spin casting. For example, a mold (for cast molding) generally comprises at least two mold sections (or portions) or mold halves, i.e. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with lens-forming material.

Methods of manufacturing mold sections for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. Nos. 4,444,711 to Schad; 4,460,534 to Boehm et at; 5,843,346 to Morrill; and 5,894,002 to Boneberger et al., which are also incorporated herein by reference.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, N.J.), or the like can be used. Other materials that allow UV light transmission could be used, such as quartz glass and sapphire.

Examples of preferred reusable molds are those disclosed in U.S. patent application Ser. Nos. 08/274,942 filed Jul. 14, 1994, 10/732,566 filed Dec. 10, 2003, 10/721,913 filed Nov. 25, 2003, and U.S. Pat. No. 6,627,124, which are incorporated by reference in their entireties. Reusable molds can be made of quartz, glass, sapphire, CaF₂, a cyclic olefin copolymer (such as for example, Topas® COC grade 8007-S10 (clear amorphous copolymer of ethylene and norbornene) from Ticona GmbH of Frankfurt, Germany and Summit, N.J., Zeonex® and Zeonor® from Zeon Chemicals LP, Louisville, Ky.), polymethylmethacrylate (PMMA), polyoxymethylene from DuPont (Delrin), Ultem® (polyetherimide) from G.E. Plastics, PrimoSpire®, etc.

Contact lenses with printed marks can be obtained by printing marks with an ink directly on preformed contact lenses or by using a “print-on-mold process” for molding a contact lens with colored prints thereon as described in U.S. Pat. No. 5,034,166 to Rawlings et al. (herein incorporated by reference in its entirety).

Any know printing methods can be used in printing marks on lens molds or contact lenses. Examples of the well-known printing methods includes without limitation pad transferring printing and inkjet printing.

Pad transfer printing is well known in the art (see. For example, U.S. Pat. Nos. 3,536,386 to Spivack; 4,582,402 and 4,704,017 to Knapp; 5,034,166 to Rawlings et al., herein incorporated by reference in their entireties). A typical example of this printing follows. An image (or patterns) is etched into metal to form a cliché. The cliché is placed in a printer. Once in the printer, the cliché is inked by either an open inkwell doctoring system or by a closed ink cup sliding across the image. Then, a silicone pad picks up the inked image from the cliché and transfers the image to the molding surface of a mold half. The silicone pads are made of a material comprising silicone that can vary in elasticity. The properties of the silicone material permit the inks to stick to the pad temporarily and fully release from the pad when it contacts a contact lens or a mold. Appropriate pad-transfer printing structures include, but are not limited to, Tampo-type printing structures (Tampo vario 90/130), rubber stamps, thimbles, doctor's blade, direct printing, or transfer printing as they are known in the art.

Any known suitable silicone pad can be used in the present invention. Silicone pads are commercially available. However, different pads could give different print qualities. A person skilled in the art will know how to select a pad for a given ink.

Clichés can be made of ceramics or metals (e.g., steel). Where a cliché is made of a steel, it would be desirable to neutralize the pH of a water-based ink (e.g., adjusted pH to 6.8˜7.8) by adding a buffer (such as, for example, phosphate salts). Images can be etched into a cliché according to any methods known to a person skilled in the art, for example, by chemical etching or laser ablation or the like. It is also desirable to clean clichés after use using standard cleaning techniques known to a person skilled in the art, such as, for example, immersion in a solvent, sonication, or mechanical abrasion.

Printing the lens using an inkjet printing process is described in published US Patent Application Nos. 2001/0050753, 2001/0085934, 2003/0119943, and 2003/0184710, herein incorporated by references in their entireties.

An ink for printing marks on contact lenses or lens molds for making contact lenses typically comprises at least one colorant, a binder polymer, a solvent, and one or more other components selected from the group consisting of a crosslinker, a humectant, a surfactant, a monomer, a polymerization initiator, an antimicrobial agent, an antioxidant agent, an anti-kogating agent, and other additives, as well known to a person skilled.

A “colorant” means either a dye or a pigment or a mixture thereof that is used to print color marks on a contact lens. In accordance with the invention, a colorant is preferably a dye and/or a transparent pigment, with former as the most preferred embodiment.

“Dye” means a substance that is soluble in a solvent and that is used to impart color. Dyes are typically transparent and absorb but do not scatter light.

A “pigment” means a powdered substance that is suspended in a liquid in which it is insoluble.

In accordance with the invention, a colorant in an ink for printing marks on contact lenses shall transmit only a first light of wavelengths to impart a desired color (preferably blue or green). The wavelengths of the first light are preferably from 400 nm to 550 nm, more preferably from 450 nm to 550 nm.

“Taking an image” or “capturing an image” can be accomplished by using a digital camera according to any known suitable methods. A person skilled in the art will understand well how to select a light source for taking a picture. An Illumination light can be a continuous or pulse light.

In accordance with the invention, any cameras can be used in the invention so long as they can generate digital images composed of pixels. A gray-scale camera is preferably used in the invention.

Where a camera is a gray-scale camera, in an image captured by the camera, the light intensity of each pixel is assigned a value of, e.g., 0 to 255, and is then registered in a coordinate system, such as Cartesian or polar coordinate system. Preferably, a 1024 by 1024 pixel array is used to capture the image for the single gray-scale image, although less or more resolution can be used if desired.

In accordance with a preferred embodiment, the light intensity of pixels of the image is registered in polar coordinates. This light intensity information in polar coordinate form is stored in a matrix wherein light intensity values at incremented angles are listed in rows of the matrix and the light intensity values for incremental radii are listed in columns. This matrix presentation of the light intensity data facilitates the analysis of defects.

Considering that the level of ambient light may cause variations in an image of a print under inspection, it is desirable that the output of a camera is normalized for variations in ambient light across the field of the image. This normalization process ensures that the image of the lens under inspection is not affected by variations in ambient light. Alternately, collimated light could be used to minimize the variations in ambient light.

It is preferably that the illumination is normalized. Uneven illumination can arise because of variations in either the illumination system or in the optical elements of the imaging system. The illumination variations typically have a slow variation across the image. The effect of these variations can be greatly reduced by using a normalization algorithm which is described in U.S. Pat. No. 6,047,082 (herein incorporated by reference in its entirety).

In accordance with the invention, a color filter is used to remove artifacts caused by printed marks upon an image of a contact lens under inspect, by allowing only the first light which is transmitted only by the printed marks on a contact lens under inspection. Any dark spots in an image against a bright background or field are likely due to the presence of cosmetic defects. Any color filters can be used in the invention, so long as they transmits only the first light (of preferably from 400 nm to 550 nm, more preferably from 450 nm to 550 nm) which transmits through the color filter. One single color filter or a combination of two or more color filter can be used in the invention, as known to a person skilled in the art. The color filter can be located between the white light illumination source and the contact lens under inspection or between the contact lens under inspection and the camera, so long as the light entering the camera for forming the image is transmitted through both the contact lens under inspection and the color filter.

Examples of cosmetic defects include without limitation mechanical defects in lens materials, foreign material (e.g., dirt or “flash”) attached to the lens, edge defects (e.g., nicks, cuts, chops and adhering foreign matter on the rim of the lens). Mechanical defects in the lens material include without limitation tears, nicks, cuts, holes, folds, other problems, and combinations thereof. Any kind of dirt or “flash” that is attached to the lens can be a functional and safety problem, and must be detected. The edge of lenses must be smooth and continuous. Any edge defects on the rim of the contact lenses must be detected and rejected. A person skilled in the art will know well how to automatically inspect the above-described defects.

Any known suitable algorithms can be used in analyzing images by computating at least a pixel area corresponding to a dark spot in the image to determine if the contact lens with printed marks thereon has any cosmetic defects.

In accordance with the invention, automatic inspection of the contact lens for cosmetic defects can be carried out in a lens holder containing a liquid. Any lens holders can be used in the invention. Examples of lens holders include without limitation lens inspection cells and lens packages or containers. Examples of lens inspection cells includes without limitation those described in U.S. Pat. Nos. 6,047,082, 6,776,044, 6,765,661, 6,614,516, 6,606,150, which are herein incorporated by references in their entireties. Any known suitable inspection procedures and algorithms can be used in the invention. The liquid can be water, a saline, a buffered saline, or a packaging solution known to a person skilled in the art.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

What is claimed is:

1. A method for automatically inspecting contact lenses having printed markings thereon for cosmetic defects, the method comprising the steps of:
(1) illuminating, with a white light, a contact lens having printed marks thereon with a white light, wherein the printed marks are composed of a colorant that transmits only a first light of wavelengths to impart a desired color;
(2) taking an image of the contact lens from a second light that is transmitted through the contact lens and a color filter, wherein the color filter is capable of transmitting only the first light; and
(3) analyzing the image for detecting cosmetic defects in the contact lenses.

2. The method of claim 1, wherein the colorant comprises a dye or a transparent pigment or both.

3. The method of claim 2, wherein the wavelengths of the first light are from 400 nm to 550 nm.

4. The method of claim 2, wherein the wavelengths of the first light are from 450 nm to 550 nm.

5. The method of claim 2, wherein the colorant imparts a color of blue or green.

6. The method of claim 2, wherein the color filter is located between a white light source for illuminating the contact lens and the contact lens under inspection.

7. The method of claim 2, wherein the color filter is located between a white the contact lens under inspection and a camera for taking the image of the contact lens.

8. The method of claim 2, wherein the cosmetic defects include mechanical defects in lens materials, foreign material attached to the lens, edge defects, or combinations thereof.

9. The method of claim 8, wherein the mechanical defects in the lens material include tears, nicks, cuts, holes, folds, or combinations thereof, wherein the edge defects include nicks, cuts, chops, adhering foreign matter on the rim of the lens, or combinations thereof.

10. The method of claim 2, wherein the contact lens is a silicone hydrogel contact lens.

11. The method of claim 2, wherein the printed marks are letters, numbers, lines, symbols, or combinations thereon.

12. The method of claim 6, wherein the wavelengths of the first light are from 400 nm to 550 nm.

13. The method of claim 6, wherein the wavelengths of the first light are from 450 nm to 550 nm.

14. The method of claim 7, wherein the wavelengths of the first light are from 400 nm to 550 nm.

15. The method of claim 7, wherein the wavelengths of the first light are from 450 nm to 550 nm.

16. The method of claim 8, wherein the wavelengths of the first light are from 400 nm to 550 nm.

17. The method of claim 8, wherein the wavelengths of the first light are from 450 nm to 550 nm.

18. The method of claim 16, wherein the mechanical defects in the lens material include tears, nicks, cuts, holes, folds, or combinations thereof, wherein the edge defects include nicks, cuts, chops, adhering foreign matter on the rim of the lens, or combinations thereof.

19. The method of claim 17, wherein the mechanical defects in the lens material include tears, nicks, cuts, holes, folds, or combinations thereof, wherein the edge defects include nicks, cuts, chops, adhering foreign matter on the rim of the lens, or combinations thereof.

20. The method of claim 1, wherein the contact lens is a silicone hydrogel contact lens, wherein the printed marks are letters, numbers, lines, symbols, or combinations thereon.
